(19) United States
(12) Patent Application Publication
(10) Pub. No.: US 2003/0107589 A1
(43) Pub. Date: Jun. 12, 2003

(54) System and process for non-real-time video-based human computer interaction

(75) Inventor: Beizhan Liu, Toronto (CA)

Correspondence Address: Beizhan Liu, 204-530 Kingston Rd., Toronto, ON, M4L 1V4, CA

(73) Assignees: Mr. Beizhan Liu; Dragon Eye System Company, Toronto (CA)

(21) Appl. No.: 10/314,625

(22) Filed: Dec. 10, 2002

Related U.S. Application Data
(60) Provisional application No. 60/355,343, filed on Feb. 11, 2002.

(51) Int. Cl. G09G 5/00

(52) U.S. Cl. 345/716; 348/716

(57) ABSTRACT

A system and a process for providing a video-based human computer interaction environment are disclosed. A modular framework defining an integrated presentation space is exported when the application is executed on a client. It includes an interactive video presentation interface, a pre-recorded video database and a database for recording the users' response videos. The user or administrator can manage the pre-recorded video database. The user can play the pre-recorded video in the video database. The user can record response video as video input to the computer according to each pre-recorded video. The user can preview the recorded video response.

### CROSS REFERENCE TO RELATED APPLICATION

This Application claims the priority benefit from U.S. Provisional Patent Application No. 60/355,343, filed Feb. 11, 2002.

### SPECIFICATIONS & DESCRIPTIONS

1. Field of the Invention

The present invention relates generally to the video based human computer interaction system and relates to the process of taking human video into the computer as a response to the pre-recorded video in the computer. Especially this invention relates to a system and a process for managing the pre-recorded video in a computer, managing the response procedure, and processing the response video in non-real-time mode.

2. Background of the Invention

We have more and more video applications with rapid growth of webcam or digital camera installations. Most of today's video applications are in real time such as video chat or live videoconference. However, in many situations, we cannot arrange a lot of staffs to deal with customer face to face in real time if we have high business traffic. We cannot deal with the repeatness of customers' similar enquiry and the pass-by-like customers. We cannot deal the heavy typing workload in the live real-time mode to care customer. Such situation leaves less efficiency to our business. That's the problem.

So we need to provide the customer with focused and efficient service to save money and time. With this invented system and process, we can arrange our service in a video database and take customers' response videos in non-real-time. So we can know the customer exactly what we want in a face-to-face-like way. We can also deliver our service exactly as what we have in a face-to-face-like way. This provides us more efficiency and accuracy to our business.

In the other field, learning and entertainment are more important in our life. Traditionally when we want to practice some video or presentation, we need a VCR, tapes, a recorder and an assistance to arrange all such things. This will involve many tape placing and replacing activities. Obviously it is not convenient for us. With this invention, we pre-record the learning videos (no matter it is a song or a public speaking) in the managed video database, then we can use this system to learn, or to practice and send our leaning result videos to the assigned destination with email.

Today there are also many media broadcasting applications (video players), however, they cannot take audience's response videos. The webcam-associated applications can take the user's video to the computer, however, it is separated and cannot record the video as a response to a specific business. They are all short of both sides and are not interactive. This invention integrates both sides into one system and one process to provide an interactive way for the customer and owner to communicate. It let the user interact with the computer or the business in non-real-time and also based on video.

### SUMMARY OF THE INVENTION

So it is therefore an object of the present invention to provide a video-based human computer interaction to meet the different specific requirements in our real life and business.

It is a further object of the invention to provide a system and process for generating business-related pre-recorded video database and taking the user's response video into the response video database so as to complete the specific business goal.

It is an additional object of the invention to provide means for the owner or user or administrator to manage the pre-recorded video database and response video database for their specific business goal.

The present invention provides a new method to let the user to interact with the computer. As mentioned in the background, the invention can be applied in a standalone environment (just like VCR, CD/DVD player, kiosk device or playstation), or in a network environment (just like the real-time application: video chat, videoconference, or media player).

As the pre-recorded video database can be organized according to the different business goal, so the same system and process can have different name in different business applications. Each application presents us an animated video based reality, which is an interactive video reality. So the technology of the applications of this invention can be named as video reality processing technology or interactive video reality processing technology. This is a new technology concept and area that I would like to propose here with this application. Here, generally, video reality or interactive video reality processing technology can be defined as a kind technology which can produce a business reality with video for user to interact with the system. Of course it is different from film and TV programs which are only for us to watch passively. For example, as mentioned in background, if we organize the question video in the pre-recorded video database in order to provide a face-to-face like customer service, the invention will be like to create a reality of an interviewer or a customer service representative either online or offline. Also as mentioned in the background, if we organize the learning video into the pre-recorded video database in order to provide a learning service, the invention will be like to create a reality of a tutor or a mentor. Of course there are many other examples or names you can give to your business with this invention.

This invention is similar to a basket or a car. The basket and car can take goods no matter what kind goods they are. This invention can have the pre-recorded video no matter what kind video you want to be the pre-recorded. The only logic behind for you to manage the pre-recorded video is the business you want to run with this invention.

### SPECIFICATIONS OF THE INVENTION

A system and a process comprising: audio video capture device, an interactive video presentation interface, a pre-recorded video database, a user response video database.

The user or administrator can manage the pre-recorded video database. They can add the video clips to the video database. They can delete the video clips from the video database.

The user can record their own video response as video input to the computer according to the pre-recorded videos. The user can preview the recorded video response.

FIG. 2 shows the detail process of the system. The first step is to manage the pre-recorded video database by the administration or the user. Then the user select the specific video set and start to play. After playing one of the video clip in the selected video set, the user start to response to the video clip. Then he previews the recorded video clip. If he satisfies, he starts to play the next video clip in the video set, otherwise he deletes the video response and restart his response. When finishing the entire video clip in the video set. He gets a specific response video set in a response video database.

The video presentation interface includes: Video presentation space and the control panel (including different command buttons) for controlling system process.

### BRIEF DESCRIPTION OF THE DRAWINGS

FIG. 1. A simplified block diagram of the system and process structure;

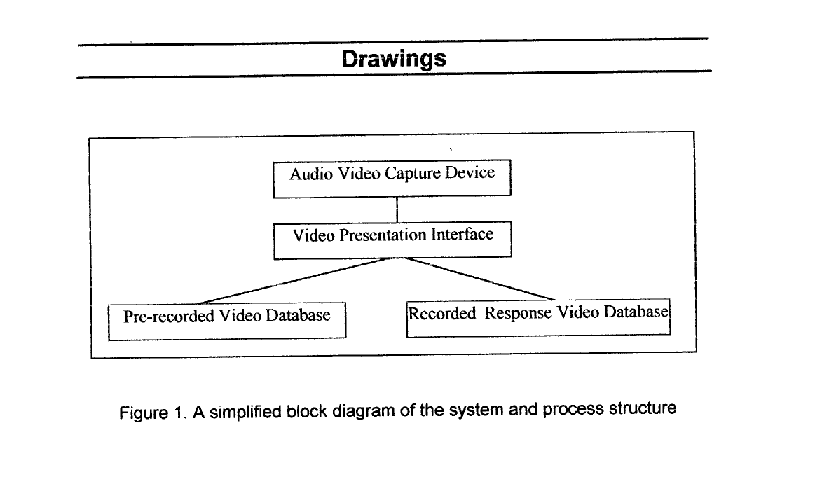

FIG. 2. A simplified block diagram of the system and process functions;

FIG. 3. A simplified diagram of the video presentation interface.

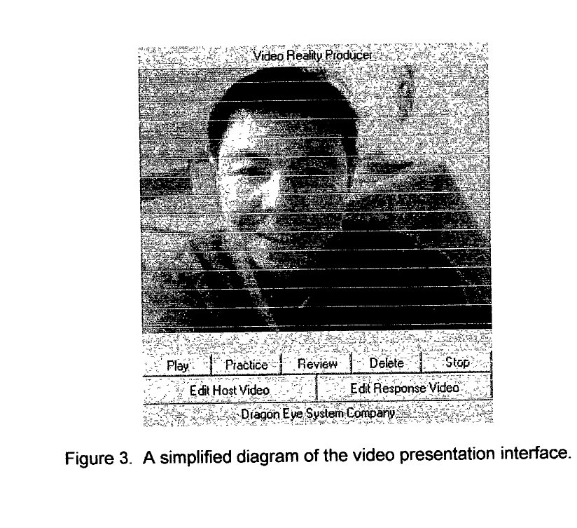

### DETAILED DESCRIPTION OF THE INVENTION

The invented system and process comprises: audio video capture device, an interactive video presentation interface, a pre-recorded video database, a user response video database.

The user or administrator can manage the pre-recorded video database. They can add the video clips to the pre-recorded video database. They can delete the video clips from the pre-recorded video database. They can rename the title of the video clip in the pre-recorded video database.

The user can record their own video response as video input to the computer according to the played video clips in the pre-recorded video database. The user can preview the recorded video response.

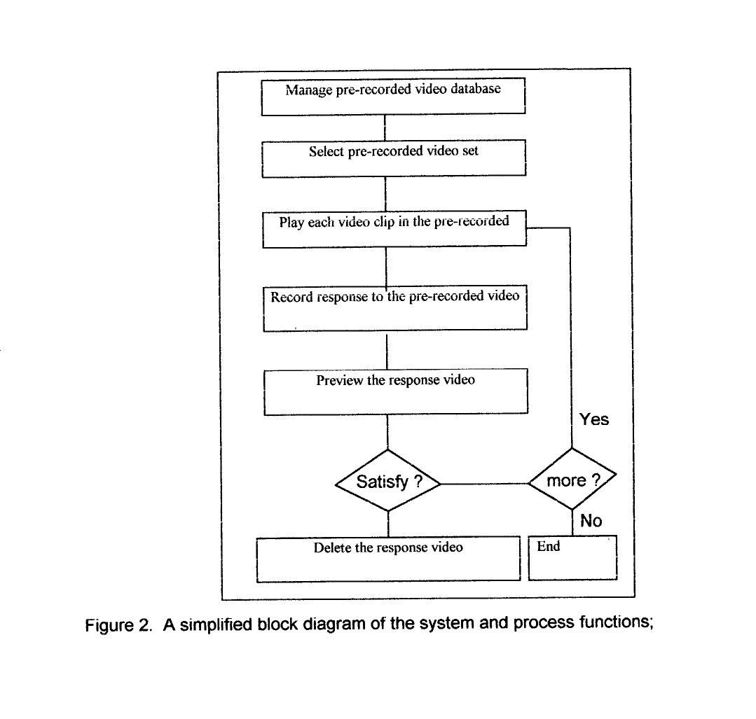

FIG. 2 shows the detail steps of the process of the system. The first step is to manage the pre-recorded video database by the administrator or the user. Then the user select the specific video set and start to play. After playing one of the video clips in the selected video set. The user start to response to this video clip. Then he previews the recorded response video clip. If he satisfied, he start to play the next video clip in the video set, otherwise he deletes the response video and start to record a new response video. When he finishes the play of all the video clips in the video set, he gets a specific response video set in the response video database.

The video presentation interface related with this invention includes: Video presentation space and the control panel (including different command buttons, such as play, play next, practice, record, preview, delete, stop, edit host video, edit response video, etc.) for controlling the system process.

One embodiment of the above invented system and process is a standalone system when we integrate the invention in a standalone environment and use the invention to interact with the computer based on video in non-real-time.

Another embodiment of the above invented system and process is an online system when we integrate the invention in a network environment such as an internet or an intranet and use the invention to interact with the computer (which is working in some kind network environment) based on video in non-real-time.

Maybe there are also other kind embodiments existed if the invention can be embedded in such an environment which is different from the above two embodiments.

As this invention is related with the human computer interaction, so it can have quite broad applications. We cannot give all the examples that this invention can be used in our life. Hereunder are some examples that we can link this invention with the specific business application.

The two embodiments can be named as interview system if the pre-recorded video clips are question video clips.

The two embodiments can be named as mentor system if the pre-recorded video clips are training video clips.

The two embodiments can be named as entertainment system if the pre-recorded video clips are entertainment related video clips.

The two embodiments can be named as consulting system if the pre-recorded video clips are consulting related video clips.

The two embodiments can be named as testing system if the pre-recorded video clips are testing related video clips.

The two embodiments can be named as journalist system if the pre-recorded video clips are journalist related video clips.

The two embodiments can be named as dating system if the pre-recorded video clips are dating related video clips.

The two embodiments can be named as language learning system if the pre-recorded video clips are language learning video clips.

The two embodiments can be named as video guard system if the pre-recorded video clips are video guard or security related video clips.

Maybe there are also other kind named systems existed if the embodiments of the invention can be used in such a business application which is different from the above mentioned business applications.

I claim:

1). A process for user to interact with the computer in a visualized way in non-real-time as a new kind Human-Computer Interface which involve audio video capture devices, a video presentation interface, pre-recorded video database, response video database and software driven the process;

2). The process in claim 1 includes the following steps:
The user (or users) or administrator first builds and manages a pre-recorded video database in the computer.
The user (or users) then selects one video set in the pre-recorded video database and starts to play. When finishing the play of one video clip in the video set, the user starts to record his response video. Then he previews the response video. If he accepts it, he starts to play the next video clip in the selected video set. Otherwise he deletes the record and restarts to record the response again.
When playing all the video clips in one video set, he creates a response video set in response video database.

3). The process in claim 2 can further includes the following steps;
The user (or users) can create or open his own account for storing the response video in the video database;

4). Where in claim 2, the user (or users) or administrator builds and manages a pre-recorded video database means the user (or users) or administrator can create or open and edit the pre-recorded video database;

5). Where in claim 2, “open the pre-recorded video database” means the user (or users) or administrator can enter the pre-recorded video database with some kind method such as login with a password and account name;

6). Where in claim 2, “edit the pre-recorded video database” means the user (or users) or administrator can edit the pre-recorded video database with some kind method such as importing new video clip, deleting video clip, and/or renaming the video clip;

7). The pre-recorded video in claim 1 & 2 can be any kind video clip or any kind visual animation data;

8). The pre-recorded video in claim 1 & 2 can be arranged in different groups or sets;

9). The pre-recorded video in claim 1 & 2 can be the video with any kind content;

10). The pre-recorded video database in claim 1 & 2 could have one or more video sets;

11). The response video in claim 2 can be the original or the processed one;

12). The database here in claim 1, 2 & 3 can be any kind data storage means, such as a video list, a video set, or a database;

13). The process of claim 2 wherein the user is prompted via use of web pages and/or servers delivered via the internet, intranet, cable TV network or any other communication networks;

14). The process of claim 2 wherein the user is prompted via the use of a wireless device;

15). The process of claim 2 wherein the user is prompted via telephone access, wherein the access is granted in response to use of a handheld device;

16). The process of claim 2 wherein the user is prompted via the use of remote kiosk device;

17). The process of claim 2 wherein the user is prompted via the use of a standalone kiosk device;

18). The process of claim 2 wherein the user is prompted via use of DVD, CD-R or CD-RW;

19). The process of claim 2 wherein the user is prompted via the use of control devices;

20). An online system which embedded the process in claim 2 via internet, intranet, wireless network or any other kind communication network for video based interaction with the user and the system.

21). The online system in claim 20 may include servers (such as: web server or application server, etc.);

22). A standalone system which embedded the process in claim 2 for video based interaction with the user and the computer;

23). The systems in claim 20 & 22 are the interview systems and the pre-recorded video are question video;

24). The systems in claim 20 & 22 are the mentor systems and the pre-recorded video are training video;

25). The systems in claim 20 & 22 are the entertainment systems and the pre-recorded video are entertainment video;

26). The systems in claim 20 & 22 are the consulting systems and the pre-recorded video are consulting related video;

27). The systems in claim 20 & 22 are the testing systems and the pre-recorded video are testing related video;

28). The systems in claim 20 & 22 are the journalist systems and the pre-recorded video are journalist related video;

29). The systems in claim 20 & 22 are the dating systems and the pre-recorded video are dating related video;

30). The systems in claim 20 & 22 are the language learning systems and the pre-recorded video are language learning related video;

31). The systems in claim 20 & 22 are the video guard systems and the pre-recorded video are video guard related video;

32). The systems in claim 20 & 22 can be the systems with any kind name with a special relation with the content of and the pre-recorded video, just like the TV can show any kind content program and the VCR can play any kind content video tape;

33). The systems in claim 20 & 22 are independent with the content of the pre-recorded video.
